(19) United States
(12) Patent Application Publication
(10) Pub. No.: US 2004/0267711 A1
(43) Pub. Date: Dec. 30, 2004

(54) Method and system for authenticating a package good

(76) Inventor: Xiao Jun Zhu, Shanghai (CN)

Correspondence Address: Philips Electronics North America Corporation, Corporate Patent Counsel, PO Box 3001, Briarcliff Manor, NY, 10510, US

(21) Appl. No.: 10/493,173

(22) PCT Filed: Oct. 17, 2002
(86) PCT No.: PCT/IB02/04358

(30) Foreign Application Priority Data
Oct. 25, 2001 (EP) 01204085.3

(51) Int. Cl. G06F 7/00

(52) U.S. Cl. 707/3

(57) ABSTRACT

The invention relates to a method of and system for establishing the authenticity of packaged goods. The method comprises the following steps: receiving from a client (1) a first code identifying the good, receiving from the client (1) a second code identifying the packaging, and verifying a correlation between said first and said second code, the packaged good being authenticated if the first and the second code correlate with a pre-selected combination. The codes identifying the good and the packaging are stored together on a list (4) or in a computer database (5) management system. The systems render possible a reliable detection of fake copies of the packaged goods.

The invention relates to a method of establishing the authenticity of a packaged good.

The invention further relates to a system for authenticating a packaged good.

There is an increasing trend in the world that customers who buy packaged goods provided with a well-known and/or established brand name are confronted with fake. For example, the packaging of a good, for instance a lamp, may be reused by another company for selling another a similar good, for example a similar lamp. The replaced good may be of a lesser quality than the good which was initially contained in the packaging. In particular, the technical quality of the replacement good may be substantially lower than that of the original good. By way of example, the lifetime of the replacement or faked good may be considerably shorter than that of the original good. In another example, the replacement good may constitute a safety risk for the user. If such a good causes injuries or any other damage, the company whose brand name is on the packaging of the good may be confronted with claims for damages.

It is an object of the invention to provide a method and system for authenticating a packaged good which substantially alleviates the above problem and which is easy to use.

This object is achieved according to the invention in a method comprising the following steps:

receiving from a client a first code identifying the good,

receiving from the client a second code identifying the packaging, and

verifying a correlation between said first and said second code, the packaged good being authenticated if the first and the second code correlate with a pre-selected combination.

The first code is applied on the good, for example, by the manufacturer of the good. The second code is applied on the packaging, for example, by the manufacturer of the package. The codes may be applied during the manufacturing of the good and of the packaging but may alternatively be applied later on. On a list, which is preferably contained in a computer database management system or which comprises a simple list (on paper), the codes identifying the good and the packaging are stored together (for example in pairs) in such a manner that a correlation between said first and second codes can be established at a later moment in time. The first code comprises, for example, a number of bits (for example, a whole number) (uniquely) identifying the good. The second code comprises, for example, a further number of bits (for example, a further whole number) (uniquely) identifying the packaging. Preferably, the number on the good (substantially) differs from the further number on the packaging. On a list made in the above-described manner pre-selected combinations of first and second codes enable the authentication of the packaged good. Upon verifying the authenticity of the packaged good, the client provides the first code and the second code and it is checked whether the first and the second code correspond to the data entered on the above-mentioned list. Upon verifying the correlation between the first and the second code, the client is informed that the packaged good is authenticated if the first and the second code correlate with a pre-selected combination. The measure according to the invention provides a so-called anti-fake system for packaged goods.

In an embodiment of the invention, verifying the correlation comprises using the first code as an input key for a database query resulting in an output key from the database, comparing said output key with the second code, the correlation being established if the output key matches with the second code.

An advantage of this embodiment is that the verification of the authenticity of the packaged good is straightforward, fast, and simple. Upon reception from a client, said first code is used as the input key for the database, preferably a computer database management system. The database is searched for the occurrence of the first code. If there is no match for the input key, the first code received from the client is wrong. This may imply that the client made an error in providing the first code or that the good is provided with a code which does not correspond to a first code on the list, thereby invalidating the good as not made by the original manufacturer. If the input key is found in the database, the database provides the corresponding output key. This output key is compared with the second code received from the client. If the output key from the database and the second code received from the client do not match, this implies that the packaging is provided with a code which does not correspond to the first code on the good in the packaging, thereby invalidating the good as not made by the original manufacturer. In this manner the authenticity of a packaged good can be easily and reliably established.

In a preferred embodiment of the invention, the method further comprises a step of providing said input key and/or said output key with flags in the database when the correlation has been established. By adding flags to the input key and/or the output key in the database upon establishing the correlation between the input key and the output key in the database, the database is provided with a so-called memory for checking that particular combination of input key and output key. When a combination of an input key and an output key is checked for the second or any subsequent time, the database may deliver a warning key that the combination has been checked before. Such a memory function has the advantage that another type of fake packaged goods can be detected. If a further manufacturer should, for example, produce packaged goods with a first code on the goods and with a second code on the packaging, which first and second codes correspond to or have been copied from a packaged good manufactured by the original manufacturer, only the client who first checked the validity of the codes on the packaged good is informed that he has bought an authentic product.

In a further preferred embodiment of the invention, the authenticity of the packaged good is invalidated upon reception of a first code corresponding to an input key in the database provided with a flag and/or reception a second code corresponding to an output key in the database provided with a flag.

Said measure detects any fake copies of the packaged goods made by any further manufacturer. Said measure, however, enables the client to check the validity of the packaged good only once. To enable a certain client to check the authenticity of the packaged good he has purchased for a second or subsequent time, the client may be provided with a verification code. In another embodiment of the invention, the method further comprises a step of providing the client with a verification code upon authenticating the packaged good, enabling further verification of the authenticity upon reception from the client of the first code, the second code, and the verification code.

In an alternative, preferred embodiment of the invention, the method further comprises a step of providing the client with a certificate (on paper or electronically) comprising the first and the second code and/or a statement relating to the authenticity of the packaged good. In this way there is no need for the client to check the validity of the first and the second code for a second or subsequent time.

In an alternative embodiment of the invention, verifying of the correlation comprises looking up the pair of the first code and the second code in a list. This is a simple method and does not require a computer database management system.

It is a further object of the invention to provide a system for authenticating a packaged good.

This object is achieved according to the invention in a system for authenticating a packaged good comprising:

receiving means for receiving from a client a first code identifying the good and a second code identifying the packaging, and

a database management system for verifying a correlation between said first and said second code, the packaged good being authenticated if the first and the second code correlate with a pre-selected combination.

Such a checking system enables the authenticity of a packaged good to be established in a straightforward, fast, and simple manner.

In an embodiment, the system comprises a device coupled to the internet, comprises a device coupled to a telephone, or comprises a customer service entity. Such devices provide a convenient checking facility for the client.

The invention and additional features, which may be optionally used to implement the invention, are apparent from and will be elucidated with reference to embodiments shown in the drawing, in which:

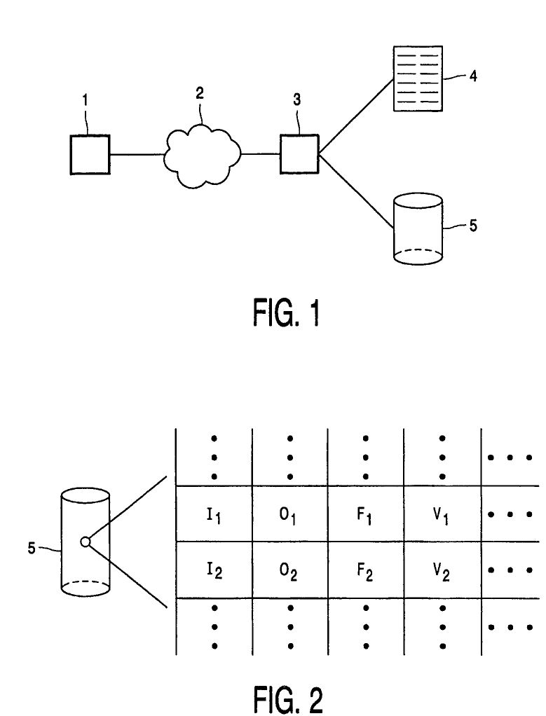

FIG. 1 schematically shows an embodiment of a system according to the invention;

FIG. 2 schematically shows the organization of the information in a computer database management system in an embodiment of the system; and

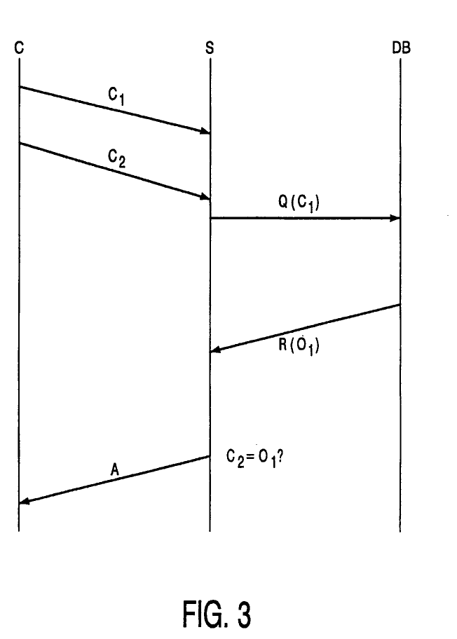

FIG. 3 is a diagram of the information flow between the client, the server, and the database of a computer database management system in an embodiment of the system.

Throughout the Figures, similar or corresponding features have been given the same reference numerals. Some of the features indicated in the drawings are typically implemented in software, and as such represent software entities, such as software modules or objects.

FIG. 1 schematically shows an embodiment of a system comprising a client 1, a network 2, a server 3, and two types of databases, i.e. a (simple) list 4 (for example on paper) or a database 5. In this example, the client 1 contacts the database via the server 3 and the network 2. This contact may be established in various ways. Preferably, the client contacts the database via a device coupled to the internet, for example a personal computer. In an alternative embodiment, the client contacts the database via a device coupled to a telephone or other means of (tele)communication. In a further embodiment, the client contacts the database via a customer service entity. The various devices mentioned provide a convenient checking facility for the client. Preferably, the authenticity of the packaged good is checked by a computer database management system. Alternatively the checking is done by hand.

If the database is a simple list, the first code provided by the client 1 is used as an input key for the list 4. Preferably, the list is sorted with respect to the first input key. If said input key is detected on the list, the corresponding output key may be read out and compared with the second code provided by the client 1. If a match is found, the packaged good is authenticated. If desired, the input key or the output key is flagged or marked in some way to enable checking whether a packaged good with the same input key has been checked by a client.

FIG. 2 schematically shows the organization of the information in a computer database management system in to an embodiment of the system. In addition, FIG. 3 is a diagram of the information flow between the client, the server, and the database of a computer database management system in an embodiment of the system.

The client (denoted “C” in FIG. 3) sends the first code C₁ identifying the good provided and the second code C₂ identifying the packaging to the server 2 (denoted “S” in FIG. 3). The first code C₁ from the client 1 is used as the input key I₁ for the database 5 (denoted “DB” in FIG. 3). Via a database query, denoted “Q(C₁)” in FIG. 3, the occurrence of the input key I₁ is checked in the database 5. If the input key I₁ is detected in the database 5, the corresponding output key O₁ is read out from the database 5, denoted R(O₁) in FIG. 3, and is subsequently compared with the second code C₂ received from the client 1, denoted “C₂=O₁?” in FIG. 3. If the answer denoted “A” in FIG. 3 to this question is yes, the client is informed that packaged good is authentic.

If desired, the input key I₁, I₂, . . . or the output key O₁, O₂, . . . may be flagged with a flag F₁, F₂, . . . (see FIG. 2) to enable checking whether a packaged good with the same input key has been checked by a client 1. The client 1 may be provided with a verification code V₁, V₂, . . . upon receiving the message that the packaged good is authentic. Said verification code enables the client 1 to verify the authenticity of the packaged good more than once. In that case the client and is asked by the computer database management system for the verification code in addition to the first code second code.

Upon authenticating the packaged good, the client may be provided with a certificate (on paper or electronically) with the first and the second code and/or a statement relating to the authenticity of the packaged good. In this way there is no need for the client to check the validity of the first and second codes for a second or subsequent time.

In order to stimulate the client to verify the authenticity of the packaged good, the checking system may be free of charge (charge free telephone call), one out of a certain number of clients may be provided with a prize upon verifying the authenticity of the packaged good, or the client may be rewarded in some other way.

Any fake copies of the packaged goods made by any further manufacturer can be reliably detected by the measures according to the embodiments of the invention.

The drawings and their description hereinbefore illustrate rather than limit the invention. It will be evident that there are numerous alternatives which fall within the scope of the appended claims. In this respect, the following closing remarks are made.

Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A method of establishing the authenticity of a packaged good comprising the following steps:
receiving from a client (1) a first code (C₁) identifying the good,
receiving from the client (1) a second code (C₁) identifying the packaging, and
verifying a correlation between said first and said second code (C₁; C₂), the packaged good being authenticated if the first and the second code (C₁; C₂) correlate with a pre-selected combination (I₁, I₂, . . . ; O₁, O₂, . . . ).

2. A method as claimed in claim 1, wherein verifying of the correlation comprises the steps of:
using the first code (C₁) as an input key (I₁, I₂, . . . ) for a database query resulting in an output key (O₁, O₂, . . . ) from the database (5), comparing said output key (O₁, O₂, . . . ) with the second code (C₂), the correlation being established if the output key (O₁, O₂, . . . ) matches with the second code (C₂).

3. A method as claimed in to claim 2, further comprising a step of providing said input key (I₁, I₂, . . . ) and/or said output key (O₁, O₂, . . . ) with flags (F₁, F₂, . . . ) in the database (5) when the correlation has been established.

4. A method as claimed in to claim 3, wherein the authenticity of the packaged good is invalidated upon reception a first code (C₁) corresponding to an input key (I₁, I₂, . . . ) in the database (5) provided with a flag (F₁, F₂, . . . ) and/or reception of a second code (C₂) corresponding to an output key in the database provided with a flag (F₁, F₂, . . . ).

5. A method as claimed in claim 1, 2, or 3, further comprising a step of providing the client (1) with a verification code (V₁, V₂, . . . ) upon authenticating the packaged good,
enabling a further verification of the authenticity upon reception from the client of the first code (C₁), the second code (C₂), and the verification code (V₁, V₂, . . . ).

6. A method as claimed in claim 1, 2, or 3, further comprising a step of providing the client (1) with a certificate comprising the first and the second code (C₁, C₂, . . . ) and/or a statement relating to the authenticity of the packaged good.

7. A method as claimed in to claim 1, 2, or 3, wherein verifying of the correlation comprises a step of looking up the pair of the first code (C₁) and the second code (C₂) in a list (4).

8. A system for authenticating a packaged good comprising:
receiving means for receiving from a client a first code identifying the good and a second code identifying the packaging, and
a database management system for verifying a correlation between said first and said second code, the packaged good being authenticated if the first and the second code correlate with a pre-selected combination.

9. A system as claimed in to claim 8, wherein the system comprises a device coupled to the internet, comprises a device coupled to a telephone, or comprises a customer service entity.
